(19) United States
(12) Patent Application Publication
(10) Pub. No.: US 2009/0022319 A1
(43) Pub. Date: Jan. 22, 2009

(54) METHOD AND APPARATUS FOR SECURING DATA AND COMMUNICATION

(76) Inventors: Mark SHAHAF, Rehovot (IL); Moshe LEVINSON, Lapid (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(21) Appl. No.: 11/779,907

(22) Filed: Jul. 19, 2007

(51) Int. Cl. H04L 9/08; H04L 9/28

(52) U.S. Cl. 380/278; 380/46

(57) ABSTRACT

A method and apparatus for securing digital data, and applications for securing multiple data items such as multiple files or messages exchanged between two communicating parties. The methods use a randomly created non-repetitive codec, with which the information to be encrypted is XORed. The codec is XORed with a user initial key, and the two results are concatenated. For securing multiple items, a master file is created comprising a number of keys, while the master file itself is encrypted with the initial key. A communication application enables a login-free communication between a client and a server, thus blocking intrusion attempts on the client side, and pishing attempts on the server side.

### BACKGROUND

1. Technical Field

The present disclosure relates to methods and apparatuses for securing computerized data.

2. Discussion of the Related Art

Data encryption is a process of transforming information to make it unreadable to anyone except those possessing special knowledge, usually referred to as a key. The result of encryption is encrypted information. Decryption is the complementary process, in which the original information is retrieved from the encrypted information. Encryption has long been used by militaries and governments to facilitate secret communication. In the digital age, encryption is used for protecting communicated information. Using a password, for example by sending a password over the Internet, as is often done in WEB applications is thus a security threat. Similarly, information stored on storage devices subject to theft, intrusion or the like is vulnerable. Further need for encryption arises from the usage of portable or removable storage devices, for which it is required that even when the device is lost or stolen, the information will not be exposed.

Currently available encryption methods use various methods and algorithms, based on mathematical principles or on private data available only to the legitimate recipient or holder of the encrypted data. However, the strength of available methods depends on but is also limited by the processing resources required for decrypting information. For example, encryption methods that rely upon the division of a number to prime numbers are more secure when larger prime numbers are involved, but the methods are nevertheless limited by the ability to determine sufficiently large prime numbers. In addition, once the used keys have a predetermined characteristic, such as being prime, they are more vulnerable than random keys. As new methods allowing fast ways for rejecting non-prime numbers were developed, illegal interception has become easier.

Even once an efficient encryption method is available, there is still a problem to encrypt multiple data items, such as multiple files residing on a storage device, continuous communication between two parties such as a client application and a server application, or the like. A party to such communication, or a user having to encrypt multiple files can usually remember and use only a limited number of passwords. However, repeating the same password is a known Achilles' heel and may help a communication interceptor or a person who has access to multiple files to decode the information.

There is thus a need in the art for a strong encryption method, which uses a predetermined password at most once, so that brute-force methods relying on the repetitiveness of passwords can not be used. There is also a need for apparatus and methods for encrypting multiple files without repeating passwords. Another need is for login-free communication establishment method, which enables secure communication between parties.

### SUMMARY

The disclosed subject matter provides an encryption method in which a random encryption key, having the length of the string to be encoded is generated, and the string, together with delimiters, suffix and prefix are encoded with the random key. The information required to re-generate the random key itself is encoded using a prime number and initial key. The encoded string and the encoded random encryption key are concatenated so that a hacker does not know the boundaries of the encryption information. A number of applications are presented, which optionally used this technique, including encoding multiple files through the usage of a master file; having the master file on a device other than the data to be encrypted; a secure communication method in which a common secret is never exchanged between parties, but rather information encoded with the common secret is exchanged; and a security center which mediates between a client application having a user ID and a server application having an application ID. The security center helps the client and the server application establish a communication channel without exchanging secret information.

In accordance with the disclosure, there is thus provided in a computing platform, an encryption method for encoding a string to be encoded, the string to be encoded having a length, the method comprising the steps of: receiving an initial key and a first prime number; generating a first temporary random string having a length related to the first prime number; generating a random string from the first temporary random string; generating a random prefix having a random length, a random suffix having a random length, and one or more first delimiters related to the first temporary random string; duplicating the random string to generate a duplicated random string, the duplicated random string having a length equal to or exceeding the sum of the length of the string to be encoded, the length of the prefix, the length of the suffix, and the length of the first delimiters; prefixing the string to be encoded by the random prefix and the first delimiters and suffixing the string to be encoded by the first delimiters to obtain an encapsulated string; activating one or more random mappings on the duplicated random string or a one-to-one mapping on the encapsulated string to obtain a random codec; performing a reversible binary operation on the random codec and the encapsulated string to obtain a content part; performing a reversible binary operation on the initial key and a concatenation of the first temporary random string and the random mappings, to obtain an encryption part; and concatenating the encoded part with the encryption part to obtain an encoded string. The method can further comprise the steps of: determining a second prime number; and generating a second temporary random string having the length of the second prime number. Within the method, the second prime number is optionally determined as the largest prime number which when multiplied by the first prime number is smaller than an upper limit and greater than a lower limit. The reversible binary operation is optionally a XOR operation. The random string can be generated by the steps of: duplicating the first temporary random string a number of times equal to the second prime number to obtain a first result; duplicating the second temporary random string a number of times equal to the first prime number to obtain a second result; and performing a binary operation on the first result and the second result to obtain the random string.

In accordance with another aspect of the disclosure, there is thus provided a method for decoding an encoded string, the encoded string being an original string encoded according to the method of claim 1, the method comprising the steps of: receiving the primary key and the first prime number; performing a reversible binary operation on the encoded string with the primary key to obtain the first temporary random string; determining a number of random mappings used during encoding; retrieving random mappings from encoded string; generating a random string from the first temporary random string; duplicating the random string to generate a duplicated random string; activating the random mappings on the duplicated random string or on the string to be decoded; determine two or more delimiters; performing a reversible binary operation on the codec with a part of the encoded string, and locating the delimiters therein; and retrieving the original string between the delimiters.

In accordance with yet another aspect of the disclosure, there is thus provided a computing platform for encoding a string to be encoded, the string to be encoded having a length, the computing platform executing computing components comprising computer instructions for: receiving a first primary key and a first prime number; generating a first temporary random string having a length related to the first prime number; generating a random string from the first temporary random string; generating a random prefix having a length, a random suffix having a length, and one or more first delimiters related to the first temporary random string; duplicating the random string to generate a duplicated random string, the duplicated random string having a length equal to or exceeding the sum of the length of the string to be encoded, the length of the prefix, the length of the suffix, and the length of the first delimiters; breaking the repetitiveness of the duplicated random string using one or more random mappings, to obtain a codec having a length equal to or exceeding the sum of the length of the string to be encoded, the length of the prefix, the length of the suffix, and the length of the first delimiters; performing a reversible binary operation on the codec and the string to be encoded to obtain a content part; performing a reversible binary operation on the initial key and a concatenation of the first temporary random string and the random mappings, to obtain an encryption part; and concatenating the encoded part with the encryption part to obtain an encoded string.

Yet another aspect of the disclosure relates to a computing platform for decoding an encoded string, the encoded string being an original string encoded by the apparatus above, the computing platform executing computing components comprising computer instructions for: receiving the primary key and the first prime number; determining a number of mappings used during encoding; performing a reversible binary operation on the encoded string and the first primary key to obtain a first temporary random string and one or more random mappings; retrieving the random mappings from encoded string; generating a random string from the first temporary random string; duplicating the random string to generate a duplicated random string; breaking the repetitiveness of the duplicated random string using the random mappings, to obtain a codec; determine at least two delimiters; performing a reversible binary operation on the codec and a part of the encoded string, and locating the at least two delimiters therein; and retrieving the original string between the at least two delimiters. The reversible binary operation is optionally a XOR operation.

Yet another aspect of the disclosure relates to an encryption method for encoding a string to be encoded, the string to be encoded having a length, within a computing platform, the method comprising the steps of: receiving initial information; generating encryption random data; generating a random codec having a length larger than the length of the string to be encoded, using the encryption random data; encoding the string to be encoded with the random codec to obtain a content part; encoding the encryption random data with the initial information to obtain an encryption part; and concatenating the content part and the encryption part to yield an encoded string. The method optionally comprises a step of manipulating the string to be encoded using the encryption random data.

Yet another aspect of the disclosure relates to a method for encoding multiple strings using an encoding method, within a computing platform, the method comprising the steps of: generating a master file, the master file comprising an indication for each of the multiple strings; for each string of the multiple strings, performing the steps of: generating a random key and a random prime number; encrypting the string using the random key and the random prime number; and associating the indication for each of the multiple strings within the master file with the random key and the random prime number; and encrypting the master file with an initial key and an initial prime number. The method can further comprise the step of receiving the initial key and the initial prime number. The method optionally comprises the steps of: generating the initial key and the initial prime number; and providing the initial key and the initial prime number. The method optionally comprises the step of generating the random key and the random prime number, wherein the key and the prime number are used in encrypting the file. The method wherein encrypting each file or encrypting the master file uses the method described above. Optionally, the initial key is used as the first key and the initial prime number is used as the first prime number.

Yet another aspect of the disclosure relates to a method for decoding multiple encoded strings in a computing platform, the method comprising the steps of:

opening a master file, the master file comprising an indication for each of the multiple strings; browsing through the multiple encoded strings; for each encoded string of the multiple encoded strings, performing the steps of: decode the encoded string into a decoded string in a temporary location; invoke a relevant application for the decoded string; and when the relevant application releases the decoded string, encode the decoded string.

Yet another aspect of the disclosure relates to a computing platform for encoding multiple strings, the computing platform executing computing components comprising computer instructions for: generating a master file, the master file comprising an indication for each of the multiple strings; for each string of the multiple strings, performing the steps of: generating a random key and a random prime number; encoding the string using the random key and the random prime number; and updating the master file with the random key and the random prime number; and encoding the master file with an initial key and an initial prime number. Within the computing platform, the component for encoding the file or the master file is the computing platform described above. The master file is optionally located on an external storage device or on a storage device other than the storage device of the encoded string.

Yet another aspect of the disclosure relates to an apparatus for protecting files stored on a storage device, the apparatus comprising a wrapper application for decoding an encrypted file, and a storage device, the storage device comprising: one or more encrypted files; and a master file comprising a key for each of the encrypted files. Within the apparatus, the wrapper application is optionally stored on the storage device, or on a second storage device. Within the apparatus, the wrapper application comprises components of the apparatus described above.

Yet another aspect of the disclosure relates to a method in a computing environment comprising a client computing platform and a server computing platform, the method exchanging encrypted strings between a client application executed by the client computing platform and a server application executed by the server computing platform, the method comprising the steps of a second application receiving initial information associated with a user ID of a user of the first application, the initial information known to the second application and to the first application or to the user; the first application creating a master file, the master file comprising one or more sets, set comprising an identifier and additional information; the first application encoding the master file with the initial information; the first application sending the master file with a user id of the user of the client application; the second application decoding the master file using the initial information associated with the user ID; the second application storing the master file; the second application preparing a response to the first application; the second application encoding the response with additional information from the master file; the second application sending the response to the first application, with an identifier associated with the additional information selected from the master file; and the first application decoding the response using the additional information associated with the identifier. The method can further comprise the steps of: the first application preparing a request to the server application; the first application encoding the request with additional information selected from the master file; the first application sending the request to the server application, with an identifier associated with the additional information selected from the master file; and the second application decoding the request using the additional information associated with the identifier. Within the method encoding is optionally performed according to the method described above. Within the method, the first application is optionally the client application and the second application is optionally the server application, or the first application is optionally the server application and the second application is optionally the client application. Within the method, the initial data optionally comprises an initial key and an initial prime number. Within the method, the additional information optionally comprises an additional key and an additional initial prime number. The additional information is optionally selected randomly from the master file. Within the method, encoding the master file or a request or a response optionally comprises concatenating encoded encryption data to the encoded master file or the request or the response.

Yet another aspect of the disclosure relates an apparatus n a computer network comprising a client computing platform and a server computing platform, the apparatus exchanging encrypted strings between a client application executed by the client computing platform and a server application executed by the server computing platform, the apparatus comprises computing components comprising computer instructions for: a second application storing initial information associated with a user ID of a user of the first application; the first application creating a master file, the master file comprising one or more sets, each set comprising an identifier, and additional information; the first application encoding the master file with the initial information; the first application sending the master file with a user id of the user of the client application; the second application decoding the master file using the initial information associated with the user id; the second application storing the master file; the second application preparing a response to the client application; the second application encoding the response with additional information selected from the master file; the second application sending the response to the client application, with an identifier associated with the additional information selected from the master file; and the first application decoding the response using the additional information associated with the identifier. Within the apparatus encoding is optionally performed using the components described above.

Yet another aspect of the disclosure relates a method in a computer network comprising a client computing platform and a server computing platform, the method authenticating a user using a client application executed by the client computing platform and a server application executed by the server computing platform, through a security center application, the method comprising the steps of: the security center application storing initial user information associated with a user ID of a user of the client application; the security center application storing initial application information associated with an application ID associated with the server application; a first application creating a one-time information; the first application encoding the one-time information with the user initial information to obtain a first one-time encoded information; the first application sending the first one-time encoded information with a user id of the user of the client application to the security center application; the security center application decoding the first one-time encoded information using the initial information associated with the user ID to obtain the one-time information; the security center application encoding the one-time information using the initial application information associated with the application ID to obtain a second one-time encoded information; the security center application sending the second one-time encoded information to the second application; and the second application decoding the second one-time encoded information to obtain the one-time information. The method optionally comprises a step of executing an encrypted session between the client application and the server application using the one-time encoded information. Within the method encoding is optionally performed according to the method described above.

Yet another aspect of the disclosure relates to an apparatus in a computer network comprising a client computing platform and a server computing platform, the apparatus authenticating a user using a client application executed by the client computing platform and a server application executed by the server computing platform, through a security center application, the apparatus comprises computing components comprising computer instructions for: a security center application storing initial user information associated with a user ID of a user of the client application; the security center application storing initial application information associated with an application ID associated with the server application; a first application creating a one-time information; the first application encoding the one-time information with the user initial information to obtain a first one-time encoded information; the first application sending the first one-time encoded information with a user id of the user of the client application to the security center application; the security center application decoding the first one-time encoded information using the initial information associated with the user ID to obtain the one-time information; the security center application encoding the one-time information using the initial application information associated with the application ID to obtain a second one-time encoded information; the security center application sending the second one-time encoded information to the second application; and the second application decoding the second one-time encoded information to obtain the one-time information. Within the apparatus encoding is optionally performed using the components described above.

Yet another aspect of the disclosure relates to a computer readable storage medium containing a set of instructions for a general purpose computer, the set of instructions comprising: receiving a first primary key and a first prime number; generating a first temporary random string having a length related to the first prime number; generating a random string from the first temporary random string; generating a random prefix having a length, a random suffix having a length, and one or more first delimiters related to the first temporary random string; duplicating the random string to generate a duplicated random string, the duplicated random string having a length exceeding the sum of the length of the string to be encoded, the length of the prefix, the length of the suffix, and the length of the delimiters; breaking the repetitiveness of the duplicated random string using a random number, to obtain a codec; performing a reversible binary operation on the codec and the string to be encoded to obtain a content part; performing a reversible binary operation on the primary key and a concatenation of the at least one first temporary string and the random number, to obtain an encryption part; and concatenating the encoded part with the encryption part to obtain an encoded string.

### BRIEF DESCRIPTION OF THE DRAWINGS

Attention is now directed to the drawing figures, where corresponding or like numerals or characters indicate corresponding or like components. In the drawings:

FIG. 1 is a schematic illustration of the process of encoding a string in accordance with preferred embodiments of the disclosed subject matter;

FIG. 2 is a flowchart of the main steps of a method for encoding a string, in accordance with preferred embodiments of the disclosed subject matter;

FIG. 3 is a flowchart of the main steps of a method for decoding a string encoded using the method shown in FIG. 2, in accordance with preferred embodiments of the disclosed subject matter;

FIG. 4 is a flowchart of the main steps in a preferred embodiment of a method for encoding multiple files;

FIG. 5A is a schematic illustration of a disk according to a preferred embodiment of a method for encoding multiple files;

FIG. 5B is a flowchart of the main steps in a preferred embodiment of a method for protecting a disk;

FIG. 6 is a flowchart of the main steps in a preferred embodiment of a method for secure bidirectional communication; and

FIG. 7 is a flowchart of the main steps in a preferred embodiment of a method for secure bidirectional communication via a security center.

### DETAILED DESCRIPTION

The disclosed subject matter provides a novel method and apparatus for encrypting strings in a digital environment. Further provided are applications for encrypting multiple strings, protecting computer disks and protecting bidirectional communication between a client application and a server application. The disclosed methods and apparatuses enable the encryption and decryption of multiple strings, without using multiple passwords or repeating passwords.

The disclosed encryption method generates a random non-repetitive codec from a prime number provided by a user. The prime number is not limited and can be in any required range. The codec is preferably generated from two randomly generated strings. The string to be encrypted, which can also undergo some manipulations such as mixing, is then XORed, or otherwise operated on, with the non-repetitive codec. In addition, factors related to the codec are encrypted with an initial key provided by the user. The encrypted codec factors are then concatenated with the encrypted string to form a single concatenated string or stream. Thus, the encrypted string is composed of two parts, a first part containing the source string or a manipulation thereof is encrypted using a randomly generated codec, wherein the second part, which is composed of data used for constructing the randomly generated codec is encrypted using the initial key.

In order to decode string constructed according to the presented scheme, the decoder has to isolate the codec factors from the concatenated string using the initial key, reconstruct the codec, and then XOR or otherwise manipulate the codec with the other part of the concatenated string, in order to retrieve the original string. Due to the concatenation, and the XORing with a random codec, brute force encryption methods lack the information of which part of the concatenated string relates to the codec and which relates to the actual information, and can not be used.

Once a method for securely encrypting a string is established, it can be used for securing multiple files, multiple messages exchanged between parties, files carried on a portable or removable device, files stored on the internet/intranet or the like.

The methods and apparatus for securing multiple files preferably encrypt every file with a specific random key. Then a master file is created, which comprises for every encrypted file its name and the specific random key with which the file was encrypted. The master file is decrypted using the initial key provided by a user, and then the encrypted files are decrypted using the respective keys as appear in the master file. A further enhancement of these methods comprises a specific computer program, such as an executable having within a random key generated for each user. The executable is used for encrypting and decrypting multiple files. This embodiment can also be implemented for securing files on a removable device or on external location, such as the Internet or an Intranet. Alternatively, the master file can be stored on a storage device other than the storage device on which the encoded files are stored.

The methods disclosed in the following drawings are preferably performed by one or more computing platforms, such as a personal computer, a mainframe computer, or any other type of computing platform provisioned with a memory device, a CPU, and one or more I/O ports. The methods are preferably implemented as one or more software components comprising data and computer instructions and organized in one or more collections such as an executable, a script file, a dynamic library, a static library, a module, or the like. The components are programmed in any programming language, such as C, C#, C++. Java, VB or the like, and under any development environment, such as .NET, J2EE or others. Alternatively, the methods can be implemented as hardware or configurable hardware such as field programmable gate array (FPGA) or application specific integrated circuit (ASIC). Thus, the disclosed methods disclosed also computing platforms executing programs for performing the disclosed methods.

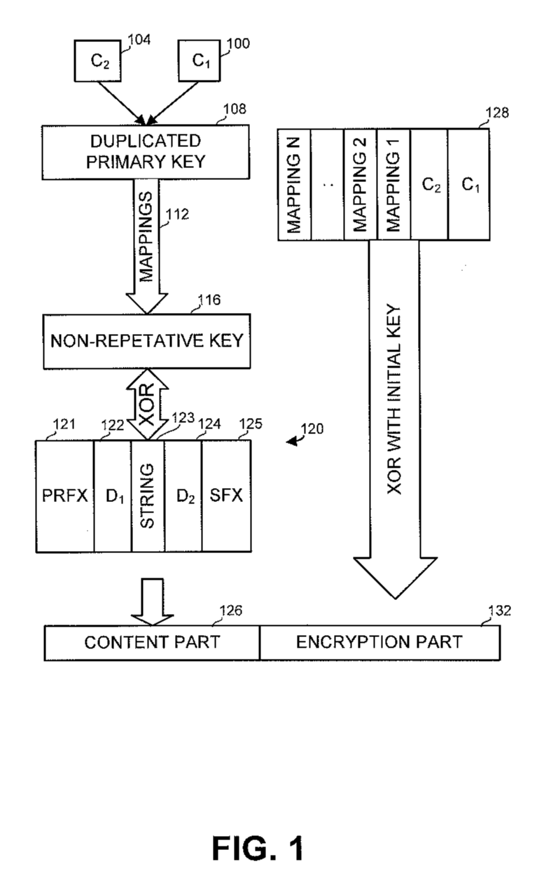

Referring now to FIG. 1, showing the principals of the encryption method. The method receives an initial key Cᵤ and a preferably prime number P₁. Then, another prime number P₂ is generated from P₁, for example by determining the largest P₂ such that P₁×P₂ is smaller than some predetermined number and greater than another predetermined number. Then, two random strings are determined, C₁ (100) having length of P₁, and C₂ (104) having length of P₂. A string is generated from C₁ (100) and C₂ (104), having the length of P₁×P₂ and duplicated enough times to be equal to the length of string 120 detailed below, resulting in string C 108. Each chunk of C 108, having the length of P₁×P₂ is then mapped onto itself using a random mapping, all mappings together indicated as 112, to generate a non-repetitive key 116. Each mapping is preferably byte-wise, i.e. each byte of C 108 is translated to another byte. However, the mapping does not have to represent a one-to-one function, rather multiple byte values can be mapped to the same value. The mapping not necessarily being a one-to-one function, but rather any random string, allows the creation of random mapping, thus enhancing the strength of the method, since there are no limitations on the mapping, which reduce the guessing possibilities. Since a different mapping is used for each chunk of C 108 having the length of the original string to be encoded, the resulting key 116 is non-repetitive. The non repetitive key, having a length exceeding the length of the original string provides for strong encryption, since the random key is of unlimited length. A XOR operation is then performed between non-repetitive key 116 and string 120. String 120 is a concatenation of a random prefix 121, a delimiter D₁ 122, the string to be encoded 123, a second delimiter D₂ 124 and a random suffix 125. Thus, string 120 is encapsulated by delimiters and prefix/suffix. D₁ 122 and D₂ 124 are preferably generated from C₁ and C₂, respectively, for example by a predetermined hash function. The result of the XOR is the content part 126 of the resulting string. C₁ (100), C₂ (104) and mappings 112, together referenced as 128 are XORed with the initial key CU (duplicated as many times as required to have the length of string 128), to receive the encryption part of the resulting string. The resulting string is thus coded using an ad-hoc generated codec, meaning that the next time the same string will be coded will result in a different coded string. The resulting encoded string is thus a concatenation of encryption part 132 and content part 126.

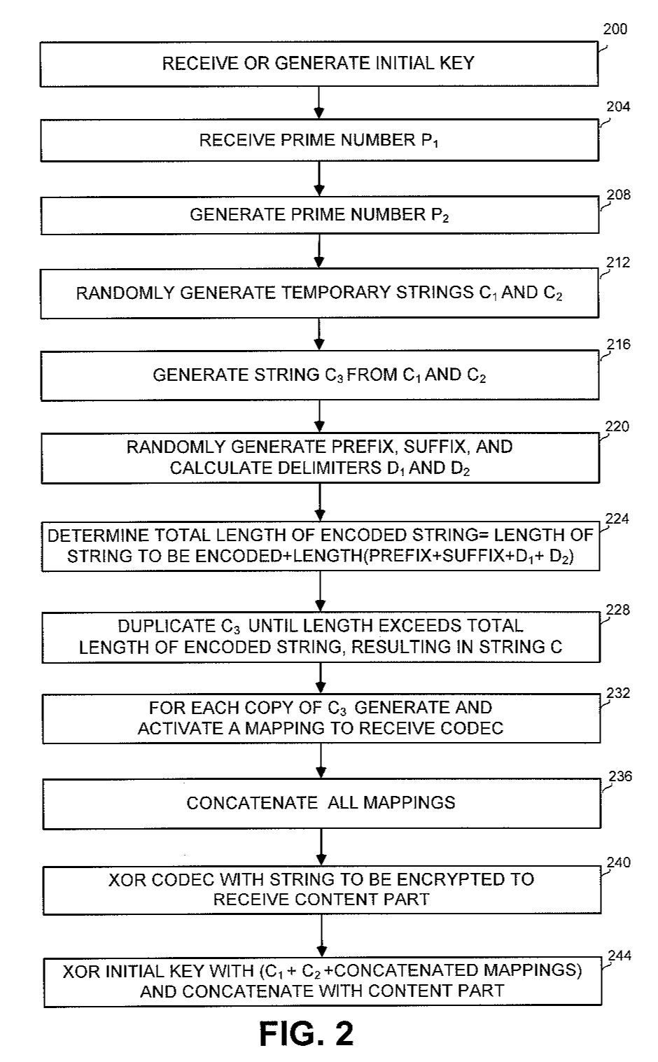

Referring now to FIG. 2, showing a flowchart of the main steps in a preferred embodiment of a method for encrypting a string. In the following description, the term XOR relates to performing the operation of exclusive bit-wise OR. When a step requires XORing two arguments of different lengths, an implicit preliminary step is required, of duplicating the shorter of the two arguments as many times as required, until the two arguments are of the same length. In an alternative embodiment, the XOR operation can be replaced with any other function, which can be expressed as an arithmetic operator, as a table or in any other way. The only limitation is that the function should be reversible, i.e. given the result and one operand, the other operand can be uniquely determined. In such case, the opposite operation is also a reversible binary operator. In addition, the terms encode and encrypt are used interchangeably, as well as the terms decode and decrypt. The method uses an initial key C_{U} and a prime number P₁, provided by the user or randomly generated. On step 200, the initial key is received or generated, and on step 204 P₁ is received or generated. On step 208, a second prime number, P₂ is generated in a predetermined manner, for example by searching the largest prime number which when multiplied by P₁ is smaller than an upper limit, such as 20000, and greater than a lower limit, such as 2000. On step 212, temporary random string C₁ having the length of P₁, and temporary random string C₂ having the length of P₂ are randomly generated. On step 216 a string C₃ is generated from C₁ and C₂. An example for the construction of C₃ is as follows: duplicate C₁ P₂ times, duplicate C₂ P₁ times, resulting in two strings having a length of P₁×P₂, and perform a binary operation on the two strings to obtain string C₃. The binary operation can be reversible, but is not required to be reversible, since during decoding the operation will be repeated rather than reversed. On step 220, random prefix and suffix are generated, and delimiters D₁ and D₂ are generated from C₁ and C₂, for example by the MD5 hash function, which is an Internet standard. The prefix and suffix enlarge the string and thus prevent the encryption of too short strings, which can be easier to decyt. On step 224 the string to be encoded is created, generated by a concatenation of the prefix, D₁, the original string to be encoded, D₂, and the suffix, and the length of this string is determined. On step 228, C₃ is duplicated enough times so as to reach or to exceed the length determined on step 224, resulting in string C. On step 232, the repetitiveness of C is broken. The repetitiveness can be broken in any desired way. In one exemplary embodiment, for each duplicate of C₃, having the length of P₁×P₂, a random mapping is generated, which maps numbers between 0 and an integer V (wherein V is smaller than or equal to P₁×P₂) into any subset of the range 0 . . . V. Then for each chunk of C₃ having a length of V bytes, each byte of the chunk is mapped according to the random mapping. The resulting string is the codec. Thus, since each duplicate of C₃ is mapped using a different mapping, the codec is random. The length of the codec, which is equal to or exceeds the length of the original string to be encoded contributes to the encoding strength, since the codec size is not limited. In another exemplary embodiment, the mapping is a one-to-one function of 0 . . . V, i.e. a random permutation. In yet another embodiment, the repetitiveness breaking is applied to the original string rather then to the codec. However, when applying the mapping to the string, the mapping can not be represented by any arbitrary string, but must be one-to-one, i.e. a random permutation, otherwise deterministic decoding will be impossible. Given a random mapping, it can be transformed in to a permutation in the following manner: creating a list of non-used numbers in the range (0 . . . V), i.e. numbers which no value is mapped to. Then for each number, if two or more numbers are mapped to it, each recurrent mapping is replaced with a number from the non-used list.

If both the codec and the source string are mixed, i.e. their repetitiveness is broken, then different mappings should be used. This can be done, for example, by using a random mapping to mix the codec, and a permutation created form the mapping as described above to decode the initial string. Thus, a random mapping and a permutation can be derived from a mapping and used in a different way.

On step 236 all mappings are concatenated. On step 240 the string generated on step 224 is XORed with the codec generated on step 232, to receive the content part. Breaking the repetitiveness as detailed above results in a non-repetitive encoded content part. Thus, breaking the repetitiveness of the codec can be done by activating a random mapping or a random permutation, on either the duplicated random string or on the original string. If the operation is performed on the original string, then the mapping must represent a permutations i.e. be one-to-one. In yet another alternative, the mapping can be applied both to the codec and to the original string.

On step 244 the initial key received from the user, C_{u,} is XORed with the string generated from concatenating C₁, C₂ and the mappings concatenated on step 236, and the result is concatenated with the content part generated in step 240. In a preferred embodiment, the initial key Cᵤ will be XORed with the mappings and some hash generated from the initial key, for example by using MD5, will be XORed with the string generated from concatenating C₁ and C₂. The result is the total string to be used as the encoded string, which comprises the encrypted original string, as well as the decryption information, which in itself is coded using the initial user password.

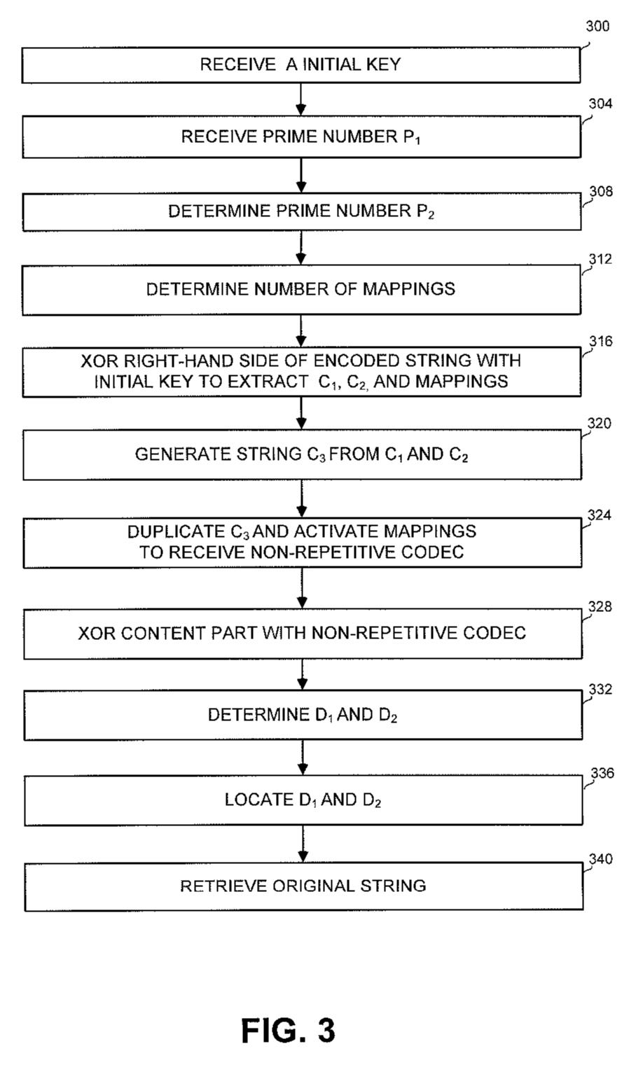

Referring now to FIG. 3, showing a flowchart of a preferred method for decrypting a string encoded with the method shown in FIG. 2. On step 300, initial key Cᵤ is received from a user, from software, via computer communication or from any other source. On step 304, a prime number P₁ is received in a similar manner. On step 308 a second prime number, P₂ is determined in the same manner used in step 208 of FIG. 2 detailed above. On step 312, the number of mappings required is determined as follows: Let T denote the length of the encoded string and let D denote the length of a string required to describe a single mapping. For example if V=256 then 256 bytes are required to describe the mapping, therefore D=256. The number of mappings is then determined by the integer part of (T−P₁−P₂−D)/(P₁×P₂+D), plus one.

Then, on step 316 C₁, C₂ and the mappings are determined by XORing the right-most P₁+P₂+number of mappings bytes of the encoded string with Cᵤ, which may be duplicated as many times as required. On step 320, string C₃ is generated from C₁ and C₂ as detailed in association with step 216 above. On step 324 string C₃ is duplicated so as to exceed the length of the total encoded string minus P₁, P₂ and the number of mappings, resulting in string C. If the first alternative for breaking repetitiveness presented in association with step 232 of FIG. 2 above was used, the mappings are then activated on each P₁×P₂ chunk of C resulting in the same non-repetitive codec generated on step 232 above. On step 328 the non-repetitive codec is XORed with the content part, i.e., the encoded string without the right hand side comprising coded C₁, C₂ and the mappings. If the second alternative for repetitiveness-breaking was used, then the mappings, is which should be one-to-one, i.e. permutations, are activated on the original string or on the result of the XOR rather than on the codec. On step 332 D₁ and D₂ are generated from C₁ and C₂, in the same manner described in step 220 above. On step 336 D₁ and D₂ are located within the string resulting form step 128, and the content between D₁ and D₂, being the original string is retrieved on step 340.

It will be apparent to a person skilled in the art that certain steps in the disclosed methods for encoding and decoding strings can be replaced with other similar or different steps. As non-limiting examples, a non-repetitive key can be generated in multiple ways, the prefix or the suffix can be omitted, D₁ and D₂ Can be generated in other manners, and the mapping scheme can be generated in any other way that enables retrieval of the mapping size. In other alternative, the method can omit generating and using P₂, and thus replace step 208, 212 ad 216 in a step of generating a string C having a length related to P₁, and use the same delimiter as D₁ and D₂.

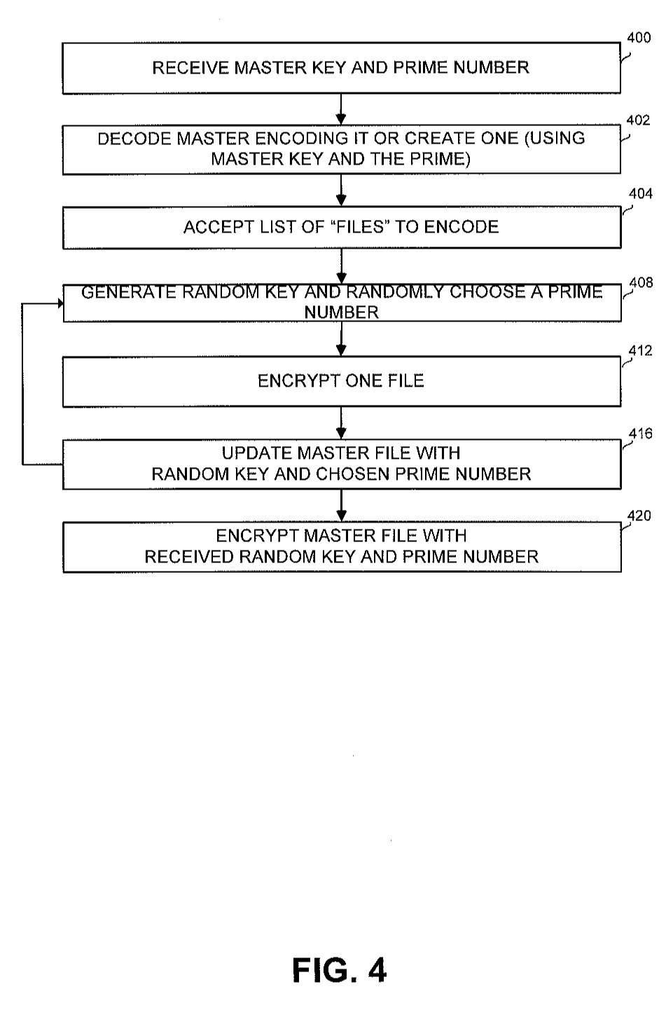

Referring now to FIG. 4, showing a flowchart of the main steps in a method for encoding multiple files or strings, stored on one or more storage devices. On step 400, an initial key and an initial prime number are received from a user via a user interface, a communication channel or in any other way. As an alternative, the random key and prime number are generated and provided to a user or an application that will receive the encrypted files. On step 402, if a master file exists for the files to be encoded or decoded, it is opened and decoded, using the initial key and initial prime number. Otherwise, a master file is created and encoded. The master file can be of any required format, such as text, binary spreadsheet or the like. On step 404 a list of files or other entities to be encoded is provided. For each item of the list, the following sequence is performed: on step 408, a random key and random prime number are optionally generated for encrypting the file or string. On step 412 the file or string is encrypted using the generated random key and random prime number, optionally according to the method disclosed in FIG. 2 above, or according to any other method. On step 416 the master file is updated with an indication to the encrypted file or string, preferably including the name, and with the random key and random file number, in a manner that enables the mapping or association of the encrypted file or string with the key and prime number. If the used encryption method requires other input than a key and a prime number, such input is generated and stored in the master file. Thus, each encrypted file or string contains its own decrypting information, the decryption information being encrypted by the randomly generated initial password and primary number stored in the Master File. Steps 408, 412 and 416 are repeated for each file or string to be encrypted, as received on step 404. On step 420, the master file is encrypted with the initial key and initial prime number received on step 400. The master file is also optionally encrypted according to the method disclosed in association with FIG. 2 above. The addressee of the encrypted files or strings receives the encrypted files or strings as well as the encrypted master file. The addressee then decodes the master file using the key and prime number received on step 402, and decodes the master file optionally according to the method disclosed in association with FIG. 3 above. Then, each file or string is decoded, optionally according to the same method, using the random key and random prime number corresponding to the file or string in the master file.

In a preferred embodiment of the disclosed method, the random key and prime number are generated as part of the method rather than received from an external source. The key and prime number are then transferred to the addressee of the encrypted files so that the files can be decrypted. It will be appreciated by a person skilled in the art that some steps can be performed in different order. Thus, for example, the initial key and prime number for encrypting the master file can be received only after all files are encrypted, and the master file can be updated with every encrypted file before or after the file is encrypted.

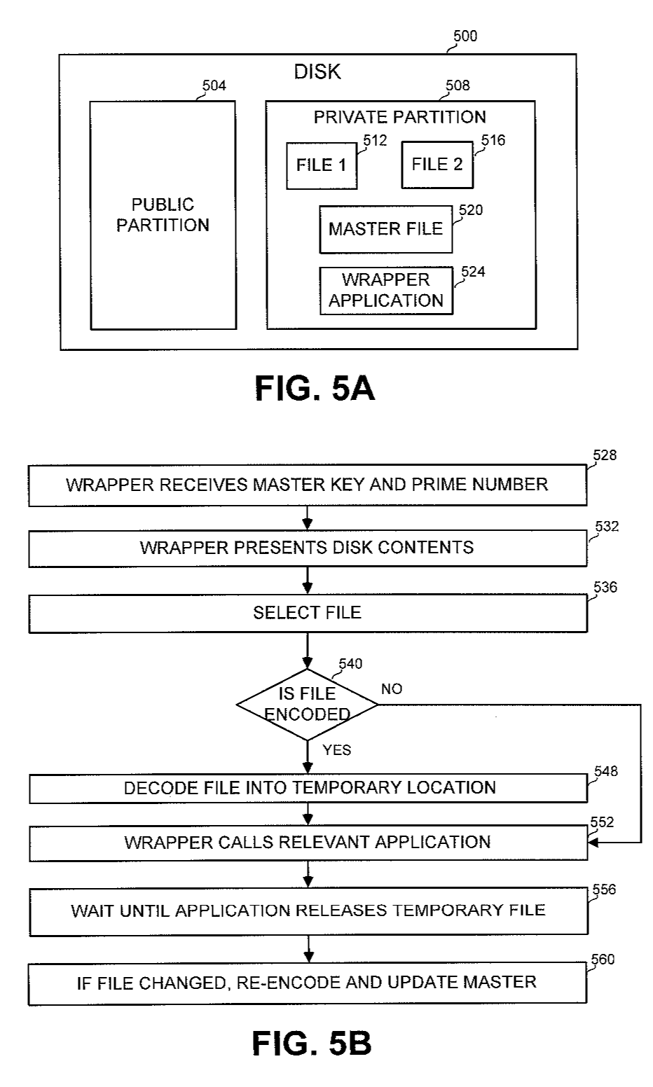

Referring now to FIGS. 5A and 5B, showing a layout of a disk comprising files that should be encrypted, and a method for using such disk.

Referring now to FIG. 5A, showing a schematic layout of a disk comprising private files which their owner or another user wishes to encrypt. The disk, generally referenced 500 optionally comprises a public partition 504 the contents of which are not required to be encrypted, and a private partition 508 which comprises files such as File 1 (512) and File 2 (516) that should be encrypted. For encrypting and decrypting the files, a master file 520 is created associating with each of the files to be encrypted, such as File 1 (512) and File 2 (516), a key and a prime number. File 1 (512) and File 2 (516) are encrypted and decrypted using the respective keys and prime numbers. The encrypted files optionally replace the original files. The key and the prime number are optionally generated in a random manner. Alternatively, the files are encrypted using any other method. The master file is also encrypted, using a key and a prime number available to the user. The encryptions are optionally performed according to the method disclosed in association with FIG. 2 above. The disk further comprises a wrapper application 524 for decoding files, which receives from a user, or has hard-coded within the key and prime number used for encrypting master file 520.

Referring now to FIG. 5B, showing the main steps in the operation of a wrapper application 524 for encoding or decoding files such as File 1 (512) and File 2 (516). On step 528, the wrapper application receives a key and prime number. The key and prime number are optionally received from a user, from a communication channel, are hard coded within the application, or are determined by the application in a deterministic manner. On step 532, the wrapper application presents the disk contents to the user or to another program, including the encoded files and the non-encoded files, in a similar manner to any file explorer program. On step 536 the user or the other application selects one or more files. On step 540 the wrapper application determines whether the selected file is encoded. If the file is encoded, then on step 548 the file is decoded into a temporary file or location, by first decoding the master file, and then decoding the file using the key and prime number associated with the file as appear in the master file. Then, and also if on step 540 it is determined that the file is not encoded, on step 552 the wrapper application invokes a relevant application for viewing or editing the file, for example according to the file extension. On step 556, the wrapper application waits until the relevant application releases the temporary file, and on step 560, once the file is released it is re-encoded (if changed or if it was not encoded before). The file is optionally re-encoded with newly generated key and prime number, the master file is optionally updated with the new key and prime number, and re-encoded.

In an alternative embodiment, the wrapper application or the master file is not stored on the same device as the encrypted files, for example when the encrypted files are stored on a portable, removable or external device. Thus, if the device is lost or stolen, if the person having the device does not have the master file or the specific wrapper application hard coded with the specific key and prime number with which the master file was encoded, the encoded files can not be decoded.

In yet another embodiment, the wrapper application can be implemented as part of the disk driver, so that accessing any of the files on the dist requires the specific disk driver.

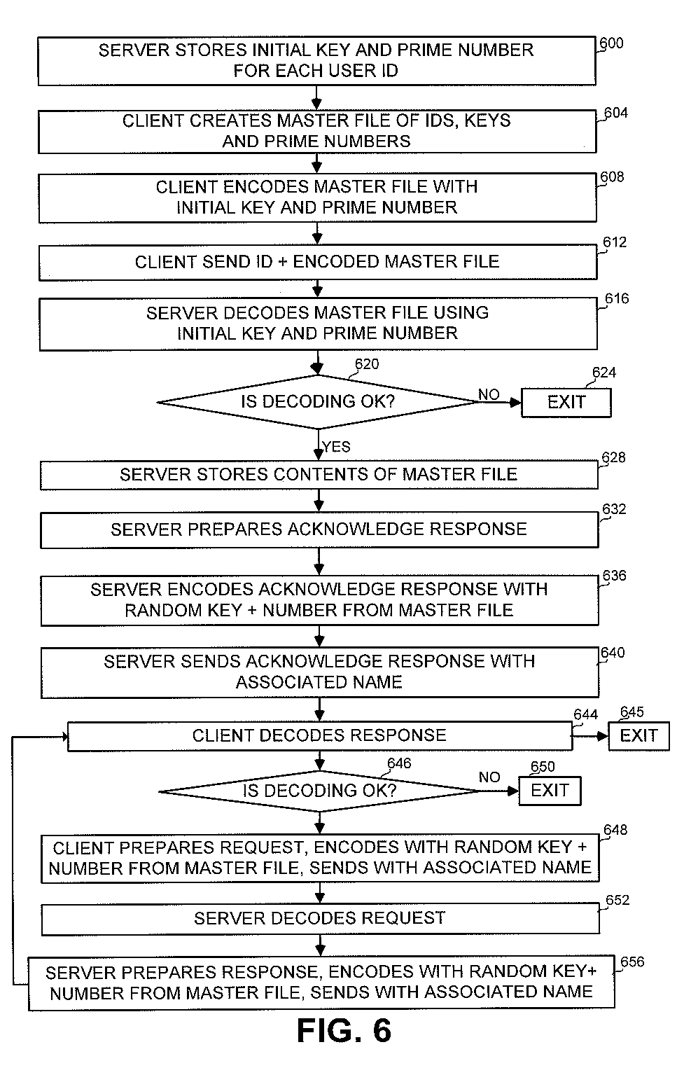

Referring now to FIG. 6, showing a flowchart of the main steps in a method for using secure communication between a client computing platform and a server computing platform which does not involve a login process in which the user sends a password for identification purposes. Each of the client and server computing platforms is preferably a mainframe computer, a desktop computer, a network computer or any other computing platform provisioned with a CPU and memory, and comprising or having access to a storage device. The computing platform are connected via a communication channel, such as a Local Area Network (LAN), a Wide Area Network (WAN), an Intranet, the Internet or the like. The server computing platform is executing a server-side application, providing services to one or more client-side applications, such as a client-side application executed by the client computing platform. The applications preferably use the encryption and decryption methods disclosed in association with FIG. 2 and FIG. 3 above. The disclosed method enables communication between a client application and a server application, without exchanging login and password information which can be intercepted by a third party and is thus sensitive to hacking methods based on pishing. In a preferred embodiment of the disclosed method, in a preliminary step the client application and the server application are provided with an initial key and an initial prime number associated with each user ID. In a preferred alternative, the initial key and initial prime number are generated by an external source and provided to the two applications, or generated by one application and provided to the other one. In the steps that follow, the term “client” refers to the client application, and the term server refers to the server application. On step 600 the server stores for each user ID the associated initial key and initial prime number. On step 604, when the client wishes to communicate with the server, it creates a master file comprising one or more triplets or sets, each triplet comprising an identifier, a key and a prime number. On step 608 the client encrypts the master file using the initial key and initial prime number. On step 612 the client sends the encrypted master file, together with the user ID to the server using any communication protocol, such as HTTP, SSL or others. Once the server receives the encoded master file with the user ID, on step 616 it retrieves from the information stored on step 600 the initial key and initial prime number associated with the user ID, and decodes the master file. On step 620, it is determined whether the decoding was successful, i.e. if the delimiters were located and of the resulting file is in the expected format. If not, the server exits and optionally sends an error message or takes another precaution measure. If it is determined that the decoding was legal, on step 628 the server stores the contents of the master file, i.e. the collection of triplets, wherein each triplet comprising an identifier, a key and a prime number. The storing is preferably temporary. Then on step 632 the server prepares an acknowledge response, such as a HTML string of the home page, and on step 636 the server encodes the HTML string with a random selection of a key and prime number combination from the master file. On step 640 the server sends the encoded string and the identifier associated with the key and prime number with which the acknowledge response was encoded. On step 644, the client receives and decodes the answer, by retrieving the key and prime number associated with the received identifier. If the client does not wish to continue the communication with the server, the client exits on step 645. On step 646 it is determined whether the response was decoded OK, which means that the server can be trusted, unlike for example what would happen with a mock-up server designed for acquiring sensitive information by “phishing”. If decoding the response is not successful, the client exits on step 650. If decoding is successful, then on step 648 the client prepares a request, encodes the request with a key and prime number randomly selected from the master file, and sends the encoded response with the associated identifier to the server. On step 652 the server decodes the request by retrieving the key and prime number associated with the identifier, and on step 656 prepares a response, decodes it and sends as detailed in association with steps 632, 636 and 640 above. Steps 644, 648, 652 and 656 repeat until the client exits.

The disclosed method enables communication between a client application and a server application without sending login information such as a password, thus enabling secure communication on top or instead of any other used method. No “common secret” such as a password is transferred between the parties over the communication channel. Rather, the content being encrypted using a “common secret” is transferred. Moreover, content encrypted with the common secret is sent only once during each session. The encryption information, being also the decryption information, is sent with the actual contents, but is itself encrypted using the “common secret”. Further, the same encryption data is preferably not used repeatedly so that messages in the same session are encrypted using with different encryption data selected randomly from a collection of ad-hoc generated data, so the information is transmitted in a highly secured manner. Since the two parties should have the same initial key and prime number and temporarily the same master file, if one of them does not possess any of the above, the other will stop the communication, thus avoiding intrusion attempts on the client side, and phishing attempts on the server side.

A person skilled in the art will appreciate that the disclosed method can be used in the reverse direction as well, i.e. the communication can be initiated on the server side, which will also issue one or more requests, while the client side will provide responses. It will further be appreciated that the disclosed encryption method, requiring a key and a prime number can be replaced with any encryption method, requiring any type of initial information to be sent form one party to the other, and additional information stored in the master file and used for encrypting individual messages.

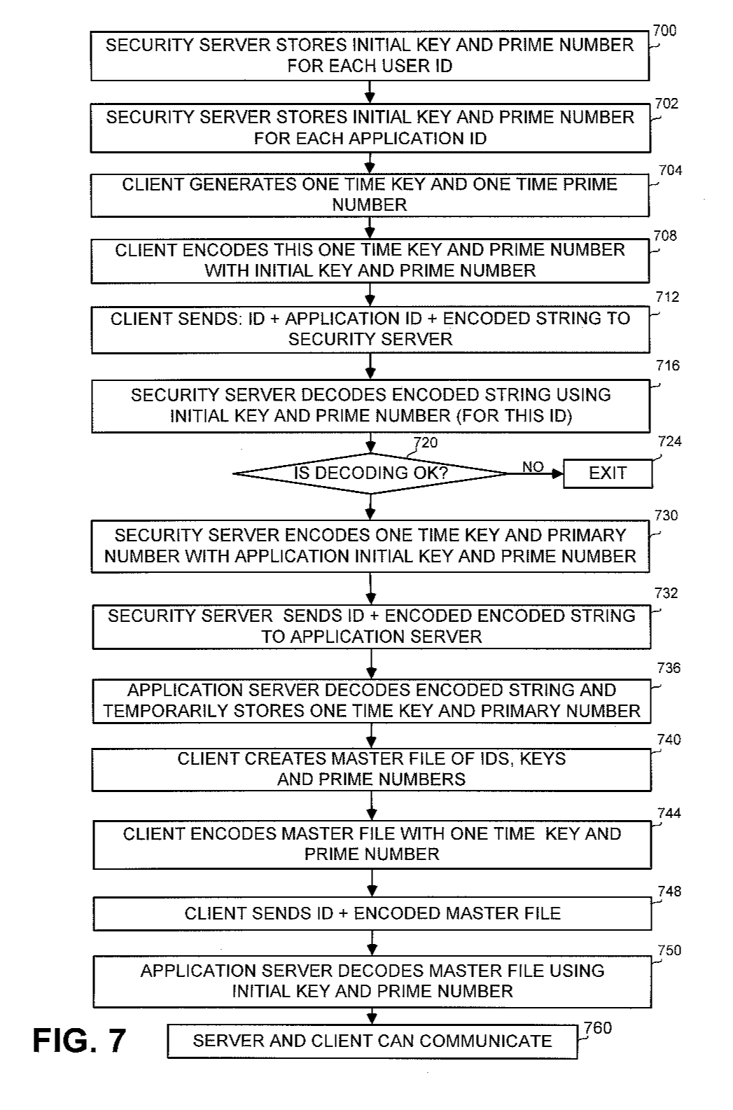

Referring now to FIG. 7, showing a flowchart of the main steps in a method for implementing a “security center” that allows a person to communicate securely with multiple applications executed on one or more servers, by using a single password for a variety of applications, but without sending the password over the network. A typical environment in which the disclosed method is used is a client computing platform and one or more server computing platform executing server applications, wherein one computing platform, preferably one of the servers executes an application referred to as a security center. The security center is thus used for authenticating the client application and a user thereof to a server application, or vice versa, by establishing a temporary “secret” known to both parties. Each of the client and the servers computing platforms is preferably a mainframe computer, a desktop computer, a network computer or any other computing platform provisioned with a CPU and memory, and comprising or having access to a storage device. The computing platforms are connected via a communication channel, such as a Local Area Network (LAN), a Wide Area Network (WAN), an Intranet, the Internet or the like. Each server computing platform is executing one or more server-side applications, providing services to one or more client-side applications, such as a client-side application executed by the client computing platform. The applications preferably use the encryption and decryption methods disclosed in association with FIG. 2 and FIG. 3 above. The disclosed method enables communication between one or more client applications and a server applications. A “common secret” is stored on, or is accessible by the security center, which mediates in session establishment performed between a client and a server without exchanging login and password information. Login and password information can be intercepted by a third party and re thus sensitive to hacking methods based on pishing. Thus, avoiding passing them enhances security. In a preferred embodiment of the disclosed method, in a preliminary step the client application and one or more security center applications are provided with an initial user key and an initial user prime number associated with each user. In a preferred alternative, the initial user key and initial user prime number are generated by an external source and provided to the client application and the server application, or generated by one application and provided to the other one. In the steps that follow, the term “client” refers to the client application, and the term server refers to the server application. On step 700 the security center stores for each user the associated user initial key and user initial prime number. On step 702 the security center stores for each application, identified by an application ID, an initial application key and an initial application prime number. On step 704, when the client wishes to communicate with one of the applications, the client generates a one time key and a one-time prime number. On step 708 the client encodes the one-time key and the one-time primary number using the initial user key and initial user prime number. On step 712 the client sends the encrypted key and primary number, together with the user ID and the application ID to the security center using any communication protocol, such as HTTP, SSL or others. Once the security center receives the one time key and one-time primary number encoded with the initial user key and initial user prime number, on step 716 the security center retrieves from the information stored on step 700 the initial user key and initial user prime number associated with the user ID, and decodes the one time key and one time primary number. On step 720, it is determined whether the decoding was successful, i.e. whether the delimiters were located and whether the resulting file, comprising the one time key and one time primary number is in the expected format. If not, the security center exits and optionally sends an error message or takes another precaution measure. If it is determined that the decoding was legal, on step 730 the security center encrypts the one time key and one primary number using the application initial key and application initial prime number associated with the application ID stored on step 702. On step 732 the security center sends the encrypted one time key and one time primary number, together with the user ID to the application server executing the relevant application, using any communication protocol, such as HTTP, SSL or others. Once the application server receives the encoded one time key and primary number, on step 736 it decodes the one time key and one time primary number and temporarily stores the user ID, the one time key and the one time primary number. The previous steps resulted in a one-time key and one-time prime number being known to the client and to the server, without the client and server sharing a common secret. The client shares a user-related common secret with the security center, and the server shares an application-related common secret with the security center, and the security center mediates them. Once it was determined on step 720 that decoding was OK, a communication session between the client and the server can be handled according to the steps described in association with FIG. 6 above.

Thus, on step 740 the client creates a master file comprising one or more triplets or sets, each triplet comprising an identifier, a key and a prime number. On step 744 the client encrypts the master file using the one time key and prime number. On step 748 the client sends the encrypted master file, together with the user ID to the application server using any communication protocol, such as HTTP, SSL or others. Once the server receives the encoded master file with the user ID, on step 750 it retrieves from the information stored on step 736 the one time key and one time prime number associated with the user ID, and decodes the master file. From now the client and application server can exchange messages as described in association with step 620 in FIG. 6.

The disclosed method provides for secure communication between a client and a server, wherein each of them shares a common secret with a security center. The security center connects them and enables them to communicate in a secure manner.

A person skilled in the art will appreciate that the disclosed method can be used in the reverse direction as well, i.e. the communication can be initiated on the server side. It will further be appreciated that the disclosed encryption method, requiring a key and a prime number can be replaced with any encryption method, requiring any type of initial information to be sent form one party to the other, and additional information stored in the master file and used for encrypting individual messages.

The disclosed subject matter exemplifies novel encryption and decryption methods and apparatuses. A preferred embodiment of the disclosed encryption method provides for generating random data for creating a random non-repetitive codec having or exceeding the length of the string to be encoded, i.e. non-limited, optionally manipulating the string to be encoded, encoding the mixed string to be encoded with the random non-repetitive codec, encrypting the random non-repetitive codec or the random data with initial user information, and concatenating the coded string and the coded codec or random data.

The methods can then be used in applications for securing multiple files, securing information stored on a disk, or securing bidirectional communication. However, the applications can be performed with other encryption and decryption methods, and are not limited to the disclosed methods.

The disclosed encryption and decryption methods are secure, since they encrypt a random codec of an unknown size. Thus, trying to decrypt messages through guessing the initial user password will not provide results, since there is no efficient way to verify whether the retrieved codec is the correct one.

The disclosed encryption and decryption methods are efficient, since they involve mainly XOR operations. However, the XOR operation can be replaced with any binary operator, including table-represented operators can be used, as long as the operator is reversible, i.e., given the result of the operation, and one operand, the other operand can be uniquely determined. In such case, the opposite operation is also a reversible binary operator. Additionally, each XOR operation can be replaced by a different operator, rather than replacing all XORs with the same operator. Thus, using methods and applications that utilize these methods will provide fast response times when accessing information, and minimize latency. The encryption and decryption methods allow the usage of unlimited codec size, since the codec is random and there is no need to search for a key that is long enough and has a predetermined characteristic, such as a prime number. In addition, the codec is purely random, non-repetitive, and of a-priori unknown size, thus preventing guessing. The method also enables the generation of an unlimited number of keys, thus decrypting multiple files or multiple communications without repeating keys, and without requiring a user to remember or to keep multiple keys, thus strengthening the methods.

While preferred embodiments of the disclosed subject matter have been described, so as to enable one of skill in the art to practice the disclosed subject matter. The preceding description is intended to be exemplary only and not be used to limit the scope of the disclosure to what has been particularly shown and described hereinabove. The scope of the disclosure should be determined by reference to the following claims.

What is claimed is:

1. In a computing platform, an encryption method for encoding a string to be encoded, the string to be encoded having a length, the method comprising the steps of:
receiving an initial key and a first prime number;
generating an at least one first temporary random string having a length related to the first prime number;
generating a random string from the at least one first temporary random string;
generating a random prefix having a random length, a random suffix having a random length, and an at least one first delimiter related to the at least one first temporary random string;
duplicating the random string to generate a duplicated random string, the duplicated random string having a length equal to or exceeding the sum of the length of the string to be encoded, the length of the prefix, the length of the suffix, and the length of the at least one first delimiter;
prefixing the string to be encoded by the random prefix and the at least one delimiter and suffixing the string to be encoded by the at least one delimiter to obtain an encapsulated string;
activating an at least one random mapping on the duplicated random string or a one-to-one mapping on the encapsulated string to obtain a random codec;
performing a reversible binary operation on the random codec and the encapsulated string to obtain a content part;
performing a reversible binary operation on the initial key and a concatenation of the at least one first temporary random string and the at least one random mapping, to obtain an encryption part; and
concatenating the encoded part with the encryption part to obtain an encoded string.

2. The method of claim 1 further comprising the steps of:
determining an at least one second prime number; and
generating an at least one second temporary random string having the length of the second prime number.

3. The method of claim 2 wherein the second prime number is determined as the largest prime number which when multiplied by the first prime number is smaller than an upper limit and greater than a lower limit.

4. The method of claim 1 wherein the reversible binary operation is a XOR operation.

5. The method of claim 2 wherein the random string is generated by the steps of:
duplicating the at least one first temporary random string a number of times equal to the at least one second prime number to obtain a first result;
duplicating the at least one second temporary random string a number of times equal to the at least one first prime number to obtain a second result; and
performing a binary operation on the first result and the second result to obtain the random string.

6. A method for decoding an encoded string, the encoded string being an original string encoded according to the method of claim 1 the method comprising the steps of:
receiving the primary key and the first prime number;
performing a reversible binary operation on the encoded string with the primary key to obtain the at least one first temporary random string;
determining a number of random mappings used during encoding;
retrieving random mappings from encoded string;
generating a random string from the at least one first temporary random string;
duplicating the random string to generate a duplicated random string;
activating the random mappings on the duplicated random string or on the string to be decoded;
determine at least two delimiters;
performing a reversible binary operation on the codec with a part of the encoded string, and locating the at least two delimiters therein; and
retrieving the original string between the at least two delimiters.

7. A computing platform for encoding a string to be encoded, the string to be encoded having a length, the computing platform executing computing components comprising computer instructions for:
receiving a first primary key and a first prime number;
generating an at least one first temporary random string having a length related to the first prime number;
generating a random string from the at least one first temporary random string;
generating a random prefix having a length, a random suffix having a length, and an at least one first delimiter related to the at least one first temporary random string;
duplicating the random string to generate a duplicated random string, the duplicated random string having a length equal to or exceeding the sum of the length of the string to be encoded, the length of the prefix, the length of the suffix, and the length of the at least one first delimiter;
breaking the repetitiveness of the duplicated random string using an at least one random mapping, to obtain a codec having a length equal to or exceeding the sum of the length of the string to be encoded, the length of the prefix, the length of the suffix, and the length of the at least one first delimiter;
performing a reversible binary operation on the codec and the string to be encoded to obtain a content part;
performing a reversible binary operation on the initial key and a concatenation of the at least one first temporary random string and the at least one random, to obtain an encryption part; and
concatenating the encoded part with the encryption part to obtain an encoded string.

8. A computing platform for decoding an encoded string, the encoded string being an original string encoded by the components of claim 7, the computing platform executing computing components comprising computer instructions for:
receiving the primary key and the first prime number;
determining a number of mappings used during encoding;
performing a reversible binary operation on the encoded string and the first primary key to obtain an at least one first temporary random string and random mappings;
retrieving the random mappings from encoded string;
generating a random string from the at least one first temporary random string;
duplicating the random string to generate a duplicated random string;
breaking the repetitiveness of the duplicated random string using the random mappings, to obtain a codec;
determine at least two delimiters;
performing a reversible binary operation on the codec and a part of the encoded string, and locating the at least two delimiters therein; and
retrieving the original string between the at least two delimiters.

9. The computing platform of claim 8 wherein the reversible binary operation is a XOR operation.

10. In a computing platform, an encryption method for encoding a string to be encoded, the string to be encoded having a length, the method comprising the steps of:
receiving initial information;
generating encryption random data;
generating a random codec having a length larger than the length of the string to be encoded, using the encryption random data;
encoding the string to be encoded with the random codec to obtain a content part;
encoding the encryption random data with the initial information to obtain an encryption part; and
concatenating the content part and the encryption part to yield an encoded string.

11. The method of claim 10 further comprising a step of manipulating the string to be encoded using the encryption random data.

12. In a computing platform, a method for encoding multiple strings using an encoding method, the method comprising the steps of:
generating a master file, the master file comprising an indication for each of the multiple strings;
for each string of the multiple strings, performing the steps of:
generating a random key and a random prime number;
encrypting the string using the random key and the random prime number; and
associating the indication for each of the multiple strings within the master file with the random key and the random prime number; and
encrypting the master file with an initial key and an initial prime number.

13. The method of claim 12 further comprising the step of receiving the initial key and the initial prime number.

14. The method of claim 12 further comprising the steps of:
generating the initial key and the initial prime number; and
providing the initial key and the initial prime number.

15. The method of claim 12 further comprising the step of generating the random key and the random prime number, wherein the key and the prime number are used in encrypting the file.

16. The method of claim 12 wherein encrypting each file or encrypting the master file uses the method of claim 1.

17. The method of claim 16 wherein the initial key is used as the first key and the initial prime number is used as the first prime number.

18. In a computing platform, a method for decoding multiple encoded strings, the method comprising the steps of:
opening a master file, the master file comprising an indication for each of the multiple strings;
browsing through the multiple encoded strings;
for each encoded string of the multiple encoded strings, performing the steps of:
decode the encoded string into a decoded string in a temporary location;
invoke a relevant application for the decoded string; and
when the relevant application releases the decoded string, encode the decoded string.

19. A computing platform for encoding multiple strings, the computing platform executing computing components comprising computer instructions for:
generating a master file, the master file comprising an indication for each of the multiple strings;
for each string of the multiple strings, performing the steps of:
generating a random key and a random prime number;
encoding the string using the random key and the random prime number; and
updating the master file with the random key and the random prime number; and
encoding the master file with an initial key and an initial prime number.

20. The computing platform of claim 19 wherein the component for encoding the file or the master file is the computing platform claim 7.

21. The computing platform of claim 19 wherein the master file is located on an external storage device or on a storage device other than the storage device of the encoded string.

22. An apparatus for protecting files stored on a storage device, the apparatus comprising a wrapper application for decoding an encrypted file, and a storage device, the storage device comprising:
an at least one encrypted file; and
a master file comprising a key for each of the at least one encrypted file.

23. The apparatus of claim 22 wherein the wrapper application is stored on the storage device.

24. The apparatus of claim 22 wherein the wrapper application is stored on a second storage device.

25. The apparatus of claim 22 wherein the wrapper application comprises components of claim 7.

26. In a computing environment comprising a client computing platform and a server computing platform, a method for exchanging encrypted strings between a client application executed by the client computing platform and a server application executed by the server computing platform, the method comprising the steps of:
a second application receiving initial information associated with a user ID of a user of the first application, the initial information known to the second application and to the first application or to the user;
the first application creating a master file, the master file comprising an at least one set, the at least one set comprising an identifier and additional information;
the first application encoding the master file with the initial information;
the first application sending the master file with a user id of the user of the client application;
the second application decoding the master file using the initial information associated with the user ID;
the second application storing the master file;
the second application preparing a response to the first application;
the second application encoding the response with additional information from the master file;
the second application sending the response to the first application, with an identifier associated with the additional information selected from the master file; and
the first application decoding the response using the additional information associated with the identifier.

27. The method of claim 26 further comprising the steps of:
the first application preparing a request to the server application;
the first application encoding the request with additional information selected from the master file;
the first application sending the request to the server application, with an identifier associated with the additional information selected from the master file; and
the second application decoding the request using the additional information associated with the identifier.

28. The method of claim 26 wherein encoding is performed according to the method of claim 1.

29. The method of claim 26 wherein the first application is the client application and the second application is the server application.

30. The method of claim 26 wherein the first application is the server application and the second application is the client application.

31. The method of claim 26 wherein the initial data comprises an initial key and an initial prime number.

32. The method of claim 26 wherein the additional information comprises an additional key and an additional initial prime number.

33. The method of claim 27 wherein the additional information is selected randomly from the master file.

34. The method of claim 26 wherein encoding the master file or a request or a response comprises concatenating encoded encryption data to the encoded master file or the request or the response.

35. In a computer network comprising a client computing platform and a server computing platform, an apparatus for exchanging encrypted strings between a client application executed by the client computing platform and a server application executed by the server computing platform, the apparatus comprises computing components comprising computer instructions for:
a second application storing initial information associated with a user ID of a user of the first application;
the first application creating a master file, the master file comprising an at least one set comprising an identifier, and additional information;
the first application encoding the master file with the initial information;
the first application sending the master file with a user id of the user of the client application;
the second application decoding the master file using the initial information associated with the user id;
the second application storing the master file;
the second application preparing a response to the client application;
the second application encoding the response with additional information selected from the master file;
the second application sending the response to the client application, with an identifier associated with the additional information selected from the master file; and
the first application decoding the response using the additional information associated with the identifier.

36. The apparatus of claim 35 wherein encoding is performed using the components of claim 7.

37. In a computer network comprising a client computing platform and a server computing platform, a method for authenticating a user using a client application executed by the client computing platform and a server application executed by the server computing platform, through a security center application, the method comprising the steps of:
the security center application storing initial user information associated with a user ID of a user of the client application;
the security center application storing initial application information associated with an application ID associated with the server application;
a first application creating a one-time information;
the first application encoding the one-time information with the user initial information to obtain a first one-time encoded information;
the first application sending the first one-time encoded information with a user id of the user of the client application to the security center application;
the security center application decoding the first one-time encoded information using the initial information associated with the user ID to obtain the one-time information;
the security center application encoding the one-time information using the initial application information associated with the application ID to obtain a second one-time encoded information;
the security center application sending the second one-time encoded information to the second application; and
the second application decoding the second one-time encoded information to obtain the one-time information.

38. The method of claim 37 further comprising the step of executing an encrypted session between the client application and the server application using the one-time encoded information.

39. The method of claim 37 wherein encoding is performed according to the method of claim 1.

40. In a computer network comprising a client computing platform and a server computing platform, an apparatus for authenticating a user using a client application executed by the client computing platform and a server application executed by the server computing platform, through a security center application, the apparatus comprises computing components comprising computer instructions for:
a security center application storing initial user information associated with a user ID of a user of the client application;
the security center application storing initial application information associated with an application ID associated with the server application;
a first application creating a one-time information;
the first application encoding the one-time information with the user initial information to obtain a first one-time encoded information;
the first application sending the first one-time encoded information with a user id of the user of the client application to the security center application;
the security center application decoding the first one-time encoded information using the initial information associated with the user ID to obtain the one-time information;
the security center application encoding the one-time information using the initial application information associated with the application ID to obtain a second one-time encoded information;
the security center application sending the second one-time encoded information to the second application; and
the second application decoding the second one-time encoded information to obtain the one-time information.

41. The apparatus of claim 39 wherein encoding is performed using the components of claim 7.

42. A computer readable storage medium containing a set of instructions for a general purpose computer, the set of instructions comprising:
receiving a first primary key and a first prime number;
generating an at least one first temporary random string having a length related to the first prime number;
generating a random string from the at least one first temporary random string;
generating a random prefix having a length, a random suffix having a length, and an at least one first delimiter related to the at least one first temporary random string;
duplicating the random string to generate a duplicated random string, the duplicated random string having a length exceeding the sum of the length of the string to be encoded, the length of the prefix, the length of the suffix, and the length of the at least one first delimiter;
breaking the repetitiveness of the duplicated random string using an at least one random number, to obtain a codec;
performing a reversible binary operation on the codec and the string to be encoded to obtain a content part;
performing a reversible binary operation on the primary key and a concatenation of the at least one first temporary string and the at least one random numbers to obtain an encryption part; and
concatenating the encoded part with the encryption part to obtain an encoded string.
